(19) United States
(12) Patent Application Publication
(10) Pub. No.: US 2013/0077223 A1
(43) Pub. Date: Mar. 28, 2013

(54) SERVER

(71) Applicant: Ji-Peng Xu, Shanghai City (CN)

(72) Inventor: Ji-Peng Xu, Shanghai City (CN)

(73) Assignee: INVENTEC CORPORATION, Taipei City (TW)

(21) Appl. No.: 13/397,054

(22) Filed: Feb. 15, 2012

(30) Foreign Application Priority Data
Sep. 28, 2011 (CN) 201110300078.1

(51) Int. Cl. G06F 1/20

(52) U.S. Cl. 361/679.4

(57) ABSTRACT

A server includes a case, a fan module, and a main board module unit. The fan module is disposed in the case and divides the case into first and second spaces. An air flow is sucked into and blown out of the fan module along a first direction. The main board module unit includes a main board module back plate and main board modules. The main board module back plate is horizontally laid in the first space. Each main board module having a hard disk is detachably inserted in the main board module back plate along a second direction, and electrically connected to the main board module back plate. Two maximum area surfaces of each main board module are parallel with the first direction. Air flow channels are formed between the main board modules extending along the first direction.

### CROSS-REFERENCE TO RELATED APPLICATION

This application claims the priority benefit of China application serial no. 201110300078.1, filed on Sep. 28, 2011. The entirety of the above-mentioned patent application is hereby incorporated by reference herein and made a part of this specification.

### BACKGROUND OF THE INVENTION

1. Field of the Invention

The present invention generally relates to an electronic device, in particular, to a server.

2. Description of Related Art

A server is a core computer serving various computers in a network system. The server is capable of providing functions such as storage and printing service for network user, and provide client to share various resources within the network environment. The server has a fundamental architecture the same as usual personal computer, that is, it includes a central processing unit (CPU), a memory, an input/output (I/O) device, and other members. Buses are interconnect the above-mentioned parts, wherein the north-bridge chip is used to connect the CPU and the memory and a southbridge chip is used to connect the I/O device. In terms of the case structure, a server has evolved in three development stages: earlier tower cases, rack servers featuring function concentration, until the emphasizing blade servers with high density computation capability.

Take a rack server as an example. The rack server is a server with the appearance designed following to a uniform design standards, and is corporately used in association with a chassis. The rack server is a tower server with an optimized structure, wherein the design principle is mainly to reduce the occupation of the server space as much as possible. Many special network apparatuses adopt the rack structure, and they are mostly flat ones so as to be ones like a drawer, such as a switch, a router, and a hardware firewall. A width of the rack server is 19 inches, a height is in the unit of U (1 U=1.75 inches=44.45 millimeters), and generally a server has several height standards of 1 U, 2 U, 3 U, 4 U, 5 U and 7 U.

A size of the chassis also follows a universal industrial standard, which has different size from 22 U to 42 U. According to the height of U, there are detachable slip trailers in a chassis, and the user may flexibly adjust the height according to the height of the server, so as to arrange the server, the hub, the disk array chassis, and other network devices. After placing the server, all the I/O cords of the servers are drawn out from the rear portion of the chassis (all interfaces of a rack server are located at the rear portion as well). All the I/O cords are placed in the line tank of the chassis and adhered with notation marks for easier management.

With the development of information technology, the cost is sharply increased for maintaining the energy consumed and the heat dissipation of the server. Therefore, how to place servers with a high density in order to save the occupation space and decrease the cost for heat dissipation is an important subject currently.

### SUMMARY OF THE INVENTION

Accordingly, the present invention is directed to a server, capable of saving a configuration space and improving heat dissipation efficiency.

The present invention provides a server, which includes a case, a fan module, and at least one main board module unit. The case has a bottom board. The fan module is disposed in the case and divides the case into a first space and a second space by the fan module. An air flow is sucked into and blown out of the fan module along a first direction. The main board module unit is disposed in the first space, and includes a main board module back plate and a plurality of main board modules. The main board module back plate is horizontally laid in the first space. Each main board module has a hard disk. The main board modules are detachably inserted in the main board module back plate along a second direction. Two maximum area surfaces of each main board module are parallel with the first direction. A plurality of air flow channels extending along the first direction are formed between the main board modules. The main board modules are electrically connected to the main board module back plate.

In an embodiment of the present invention, the case has a plurality of detachable upper covers, the number of the at least one main board module unit is multiple, and the upper covers respectively cover the fan module and the main board module units.

In an embodiment of the present invention, the server further includes a plurality of power modules, located in the second space and disposed on the bottom board, in which the power modules are mutually redundant.

In an embodiment of the present invention, the server further includes a power back plate, disposed on the bottom board and located between the power modules and the main board modules, and electrically connected to the power modules and the main board module back plate.

In an embodiment of the present invention, the server further includes a plurality of integrated management modules, in which the integrated management modules are disposed in the second space and are mutually redundant, and are electrically connected to the power back plate.

In an embodiment of the present invention, the server further includes a plurality of switch modules, disposed in the second space, parallel with each other, and electrically connected to the power back plate.

In an embodiment of the present invention, the fan module is electrically connected to the power back plate.

In an embodiment of the present invention, the server further includes a plurality of power cables, in which the number of the at least one main board module unit is multiple, the power cables are respectively connected to the main board module back plates, and electrically connected to the power back plate.

In an embodiment of the present invention, the first space, the fan module, and the second space are arranged in a sequence from a front end to a rear end of the case.

In an embodiment of the present invention, the first space, the fan module, and the second space are arranged in a sequence from a right end to a left end or from the left end to the right end of the case.

Based on the above-mentioned, in the present invention, the plurality of main board modules are detachably inserted in the main board module back plate and each main board module has a hard disk, so as to fully utilize the space in the case, wherein saving the configuration space. In addition, the fan module is disposed in the case, the air flow is sucked into and blow out of the fan module along the first direction, and the air flow channels are formed between the main board modules extending along the first direction, the fan module can increase the efficiency of heat dissipation on the main board modules, the hard disks and the server.

In order to make the aforementioned features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of a server according to an embodiment of the present invention.

FIG. 2 is a three-dimensional view of inner components of the server of FIG. 1.

FIG. 3 is a three-dimensional view of a main board module of FIG. 1.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

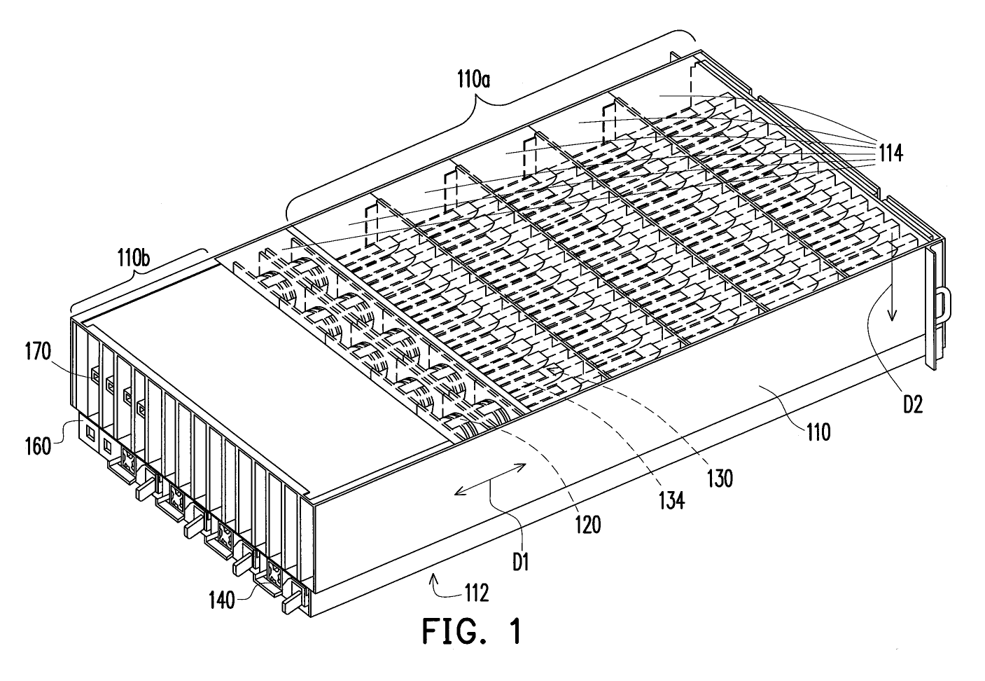

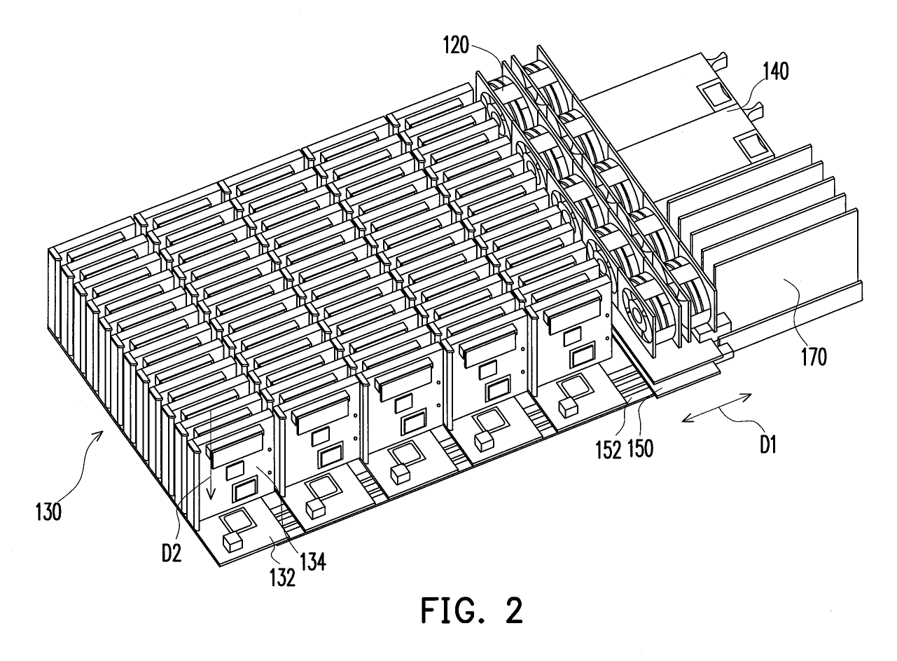

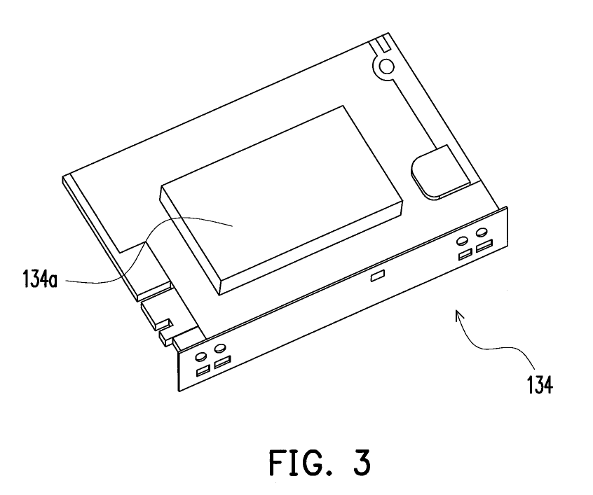

FIG. 1 is a three-dimensional view of a server according to an embodiment of the present invention, FIG. 2 is a three-dimensional view of inner components of the server of FIG. 1, and FIG. 3 is a three-dimensional view of a main board module of FIG. 1. Referring to FIG. 1 to FIG. 3, the server 100 of this embodiment includes a case 110, a fan module 120, and at least one main board module unit 130 (a plurality of main board module units is shown in the figure). The case 110 has a bottom board 112. The fan module 120 is disposed in the case 110 and divides the case 110 into a first space 110a and a second space 110b.

An air outlet direction of the fan module 120 is parallel with a first direction D1, and an air flow is sucked into and blown out of the fan module along the first direction D1. The main board module unit 120 is disposed in the first space 110a and the main board module unit 120 has a main board module back plate 132 and a plurality of main board modules 134. The main board module back plate 132 is horizontally laid in the first space 110a, and each main board module 134 has a hard disk 134a. The main board modules 134 are detachably inserted in the main board module back plate 132, wherein along a second direction D2 and the second direction D2 is vertical to the first direction D1. The main board modules 134 are electrically connected to the main board module back plate 132. Two maximum area surfaces of each main board module 134 are parallel with the first direction D1, so that a plurality of air flow channels extending along the first direction D1 are formed between the main board modules 134.

In the above configuration, the plurality of main board modules 134 is detachably inserted in the main board module back plate 132, and each main board module 134 is disposed with a hard disk 134, so as to fully utilize the space in the case 110. In addition, the fan module 120 is disposed in the case 110, the air flow is sucked into and blown out of the fan module 120 along the first direction D1, the air flow channels are formed between the main board modules 134 extending along the first direction Dl, and the fan module 120 can increase the efficiency of heat dissipation on the main board modules 134, the hard disks 134 and the server 100.

In this embodiment, the case 110 has a plurality of detachable upper covers 114, and the upper covers 114 respectively cover the fan module 120 and the main board module units 130. When maintaining one main board module unit 130 or the fan module 120, it is only need to open the upper cover 114 which is covered the main board unit 130 or the fan module 120.

The server 100 of this embodiment further includes a plurality of power modules 140. The power modules 140 are located in the second space 110b and disposed on the bottom board 112. The power modules 140 are mutually redundant for the more stable operation of the server 100. The server 100 further includes a power back plate 150 and a plurality of power cables 152. The power back plate 150 is disposed on the bottom board 112 and located between the power modules 140 and the main board modules 134. The power back plate 150 is electrically connected to the power modules 140. The power cables 152 are respectively connected to the main board module back plates 132, and are electrically connected to the power back plate 150 as well, and the power modules 140 supply power to the main board module units 130 through the power back plate 150. The fan module 120 of this embodiment is electrically connected to the power back plate 150, wherein the power modules 140 supply power to the fan module 120 through the power back plate 150.

In this embodiment, the server 100 further includes a plurality of integrated management modules 160. The integrated management modules 160 are disposed in the second space 110b. The integrated management modules 160 are mutually redundant for more stable operation of the server 100. The integrated management modules 160 are electrically connected to the power back plate 150. The power module 140 supply power to the integrated management modules 160 through the power back plate 150.

In this embodiment, the server 100 further includes a plurality of switch modules 170. The switch modules 170 are disposed in the second space 110b, parallel with each other and vertical to the bottom board 112. The switch modules 170 electrically connect to the power back plate 150, so that the power modules 140 supply power to the switch modules 170 through the power back plate 150.

In this embodiment, the first space 110a, the fan module 120, and the second space 110b are arranged in a sequence from a front end to a rear end of the case 110. However, the present invention is not limited thereto, and in other embodiments, the first space 110a, the fan module 120, and the second space 110b may be arranged in a sequence from a right end to a left end or from the left end to the right end of the case 110.

Based on the above, in the present invention, the plurality of main board modules is detachably inserted in the main board module back plate, and each main board module has a hard disk, so as to fully utilize the space in the case. In addition, the fan module is disposed in the case. An air flow is sucked into and blown out from the fan module along the first direction and between the main board modules forming an air flow channels which extends along the first direction. The fan module can increase efficiency of heat dissipation on the main board modules and the hard disks and the server. Further, the plurality of power modules, the plurality of integrated modules, and the plurality of switch modules are disposed in the second space, and the main board modules, the fan modules, the integrated modules, and the switch modules receive electrical power from the power modules through the same power back plate, so as to fully utilize the rack space.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A server, comprising:
a case, comprising a bottom board;
a fan module, disposed in the case and dividing the case into a first space and a second space, wherein an air flow is sucked into and blown out of the fan module along a first direction; and
at least one main board module unit, disposed in the first space, and comprising:
a main board module back plate, horizontally laid in the first space; and
a plurality of main board modules, wherein each main board module comprises a hard disk, the main board modules are detachably inserted in the main board module back plate along a second direction, wherein two maximum area surfaces of each main board module are parallel with the first direction, and a plurality of air flow channels are formed between the main board modules, wherein the air flow channels are extending along the first direction, and the main board modules are electrically connected to the main board module back plate.

2. The server according to claim 1, wherein the case comprises a plurality of detachable upper covers, the number of the at least one main board module unit is multiple, and the upper covers respectively cover the fan module and the main board module units.

3. The server according to claim 1, further comprising a plurality of power modules, located in the second space and disposed on the bottom board, wherein the power modules are mutually redundant.

4. The server according to claim 3, further comprising a power back plate, disposed on the bottom board and located between the power modules and the main board modules, and electrically connected to the power modules and the main board module back plate.

5. The server according to claim 4, further comprising a plurality of integrated management modules, wherein the integrated management modules are disposed in the second space and are mutually redundant, and are electrically connected to the power back plate.

6. The server according to claim 4, further comprising a plurality of switch modules, disposed in the second space, parallel with each other, and electrically connected to the power back plate.

7. The server according to claim 4, wherein the fan module is electrically connected to the power back plate.

8. The server according to claim 4, further comprising a plurality of power cables, wherein the number of the at least one main board module unit is multiple, the power cables are respectively connected to the main board module back plates, and electrically connected to the power back plate.

9. The server according to claim 1, wherein the first space, the fan module, and the second space are arranged in a sequence from a front end to a rear end of the case.

10. The server according to claim 1, wherein the first space, the fan module, and the second space are arranged in a sequence from a right end to a left end or from the left end to the right end of the case.
